(19) United States
(12) Patent Application Publication
(10) Pub. No.: US 2004/0008589 A1
(43) Pub. Date: Jan. 15, 2004

(54) Apparatus and method for timing events

(76) Inventors: Erik A. McMillan, Austin, TX (US); Mark W. Blecher, Plano, TX (US)

Correspondence Address: JOHNSON & ASSOCIATES, PO BOX 90698, AUSTIN, TX, 78709-0698, US

(21) Appl. No.: 10/600,940

(22) Filed: Jun. 20, 2003

Related U.S. Application Data
(60) Provisional application No. 60/390,408, filed on Jun. 24, 2002.

(51) Int. Cl. G04B 19/00

(52) U.S. Cl. 368/223

(57) ABSTRACT

A method and apparatus is provided for timing events and sub-events. A timer allows a user to time the duration of an event. During the event, sub-events may also be timed, by use of a sub-event trigger (e.g., a sub-event button). A display can display information relating to the timed event and sub-event. For example, the timer may display the time elapsed or time remaining in the event, the number of past sub-events, the number of remaining sub-events, and/or statistical information relating to the timed event and sub-events. One application of the timer is as an aid to a person practicing for, or taking, a standardized test.

### CROSS REFERENCE TO RELATED APPLICATION

This application claims priority under 35 U.S.C. § 119 to co-pending, commonly owned U.S. provisional patent application serial No. 60/390,408 filed on Jun. 24, 2002, entitled “TEST-MAN”.

### FIELD OF THE INVENTION

This invention relates to timers. In particular, this invention is drawn to an apparatus or method for timing events.

### BACKGROUND OF THE INVENTION

In almost all human endeavors, the time allotted to finish a specific task or project is limited. Although there are many factors involved in completing a designated task optimally, time is usually a major contributor.

For example, while it is true that better knowledge of the subject matter on a timed exam is paramount in achieving a satisfactory score, such knowledge alone can not assure the test taker a superior score. The reason involves the time limits placed on completing the test. That is, even if, the test taker knows how to complete each problem successfully, if he/she is not able to finish in the allotted time frame, the score will be materially lowered. Therefore, in order to maximize the score on any given test, the test taker must combine their knowledge of the subject with a method of time management.

Every year thousands of students graduate from high school, college and graduate school looking for ways to further their education. Before applying to universities in hope of acceptance, students must pass certain standardized tests. To get into college on the under graduate level, you must take the SAT and SAT II tests. To get into law school students must take the LSAT, for medical school the MCAT, and for Masters of Business Administration the GMAT. There are hundreds of tests to take for hundreds of different professions and degrees.

As mentioned above, one of the reasons standardized tests are so difficult is the short time constraint put on the tests. An example, from the LSAT, is finishing 26 complicated logical reasoning multiple-choice questions in 35 minutes. The average test taker cannot accomplish this task. The same goes for all other standardized tests: test takers cannot finish on time. In fact, the time factor is probably the single most important factor in determining whether an applicant scores acceptably high and gets into the school of their choice, or whether their scores are unacceptable and they have to settle for a less satisfactory school or a different avocation all together. The reason is that, with ample time, many of the exam questions can be answered correctly. The ability to manage this time is crucial.

One problem is that students don't usually have enough time on standardized tests, and as a result, either leave an unacceptably high number of questions unanswered, or resort to a very low percentage “guessing” strategy. There are various and cumulative reasons for this time issue—including allocating an inefficiently high amount of time on any one question. For example, a student may be able to answer a question on average in 1 minute. However, on a more difficult question, the student spends 5 minutes. However, even if this question is answered correctly, if it leads to 5 unanswered questions, the student's test score will suffer materially. Just as it is with those taking standardized tests, it is also difficult for students at all levels of education to finish their exams on time. Elementary, junior high, high school, college, graduate, and professional exams all have tough time constraints. Students must understand and practice good time management techniques through out school in order to get good grades and move on to the next level of education.

There are also other tasks that are carried out in anyone's life that require good time management techniques. Exercise is another task that timing per a specific event is very important. If you need to run 10 laps in a total of 20 minutes, it would be useful to know how fast to run each lap. Plus, you would need to know how long you had been running each lap, and how much time you had remaining on each lap. The same would apply to swimming laps or running miles.

There are many simple count-up or count-down timers on the market that students are currently employing for practice test-taking use. But these timers make beeping noises and are prohibited for use on test day. The only option a user has is to modify exiting timers by cutting wires or removing speakers. There are also no prior art timers that address the other problems discussed.

There is a need for a better time management tool to help time specifics of certain events to finish them on time. There are numerous applications or professions that need specific time management tools, in addition to the ones mentioned in this description. There is also a need in the market for a timer to address the problems discussed above.

There are also insufficient guidelines or methods in the prior art for how to efficiently manage time on tests, sporting events or other life tasks using a timer. There are very important timing strategies that pertain to each possible timed event. These strategies would show the best ways to utilize the timer for maximum efficiency. For example, on the LSAT, there are 4 unique sections that each must be approached in a different manner with regards to timing strategy. Logical Reasoning, Reading Comprehension, Logic Games, and Writing are all integral parts of the LSAT. The Logic games section of the exam has a completely different time strategy than the Logical Reasoning section. One is based on 4 main time sections, and the other on time per each individual question. A good set of timing methods and strategies is needed to help anyone keep track of any timed event.

### SUMMARY OF THE INVENTION

An method is provided for displaying examination information during one or more portions of an examination, comprising the steps of: providing a timer for timing the duration of a portion of the examination; tracking the number of questions answered by a user during the portion of the examination; and displaying information relating to both the time remaining in the portion of the examination and to the number of questions remaining in the portion of the examination.

One embodiment provides a timer for timing an event comprising: a display; one or more buttons for allowing a user to start and stop the timer; and a visual indicator for alerting a user to an event, wherein the user is alerted without using an audible device.

Another embodiment provides a method of displaying information during a timed event having sub-events, comprising the steps of: providing a timer for timing the duration of the event; tracking the number of sub-events during the event; and displaying information relating to both the time remaining in the event and to the number of sub-events.

Other objects, features, and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements and in which:

FIG. 1 is a side view of one embodiment of a timer of the present invention.

FIG. 2 is an isometric view of the timer shown in FIG. 1.

FIG. 3 is a view of a timer of the present invention.

FIG. 4 is an enlarged view of the display shown in FIG. 3, illustrating an example of information that can be displayed.

### DETAILED DESCRIPTION

Generally, the present invention provides a method and apparatus for timing events and sub-events that solves the problems discussed above. The timer allows a user to time the duration of an event. During the event, sub-events may also be timed, by use of a sub-event trigger (e.g., a sub-event button). A display can display information relating to the timed event and sub-event. For example, the timer may display the time elapsed or time remaining in the event, the number of past sub-events, the number of remaining sub-events, and/or statistical information relating to the timed event and sub-events.

In one example, a timer of the present invention is used to help students efficiently and silently monitor time on standardized tests such as the LSAT, MCAT, GMAT, SAT, GRE, etc. The following description will describe the use of the invention in a testing environment. However, in addition to a testing environment, a timer of the present invention may also be used for any other task requiring something to be timed.

A timer of the present invention is a device that gives users the edge they need to score higher on standardized tests. In addition, a timer of the present invention can also keep track of the total time elapsed, number of unanswered questions remaining, and average time remaining per unanswered question available in order to allow the students to allot the optimal amount of time per question, and as a result, maximize their chances of getting the score necessary to meet their preferred schools entrance criteria. A timer of the present invention is capable of monitoring test time, time per question, and statistics pertinent to getting the test done on time. Practicing with this product and utilizing it on test day will increase a user's scores.

A timer of the present invention can be used to help users take standardized tests. One advantage provided by the invention is to increase time per question efficiency, decrease anxiety, and thereby increase test scores. By using a timer of the present invention, a test taker focuses less on the time left on the test, time left on the section and time per question; and more on getting each question correct.

In some embodiments, a timer of the present invention has an LCD screen, which displays the time information to the test taker. The test taker can view the following in real time: total time elapsed on the test or test section (counting up from 0, or down from the time allowed per section), the number of unanswered questions remaining per section, the question currently being solved, the allotted time remaining on the current question, and the available time remaining for each unanswered question.

By using the invention, the test taker is able to: set the amount of time on the test section, set the amount of questions in the section, set which question is currently being worked on, recall from memory certain individualized time data gleaned from earlier practice exams, receive a “end of section” (e.g., at 1 minute) warning light, receive a warning light (e.g., at 3 seconds) when too much time is spent on one question, adjust the warning time or turn the warning light off, choose to view either “Time Remaining” (count down) per section or “Time Used” (count up) per section. The user can also switch in between “count down” and “count up” while the time is active. For example, assume that a user sets the timer for 30 minutes, and presses Start. After 1 minute has passed, the timer will read “29 minutes” in Count Down mode. Then, a user can press a button to switch to Count Up mode. When a user pushes the button, the timer will read “1 minute” and continues counting up. The time per question features works in both Count Down and Count Up mode. The current time (clock) can be viewed while actively using the timer as well. In one example, while counting down, the clock button can be pressed and the current time is shown for 3 seconds and then returns to the count down.

In one example, the timer is implemented in the form of an electronic device. A timer of the present invention may be implemented as a stand alone device, or can be incorporated into another device, such as a watch, telephone, pen, alarm clock, car dash device, tool, etc. The timer can also be implemented as a software application and run on a PDA, computer, cell phone, micro device, etc. The use of a timer can remain the same regardless of how it is implemented. For example, the timer can be used to help time any activity with a set amount of time and certain number of tasks (questions to answer, laps to run, patients to see, lawns to mow, cars to wash, etc).

One example for a use of the invention is with the GMAT and GRE. These standardized tests are administered on a computer and timing devices, pencils, paper, etc are not allowed into the test room. The invention can be implemented on the computers where these tests are given. Within the computer exam, the timer can show all necessary timing information to the test taker.

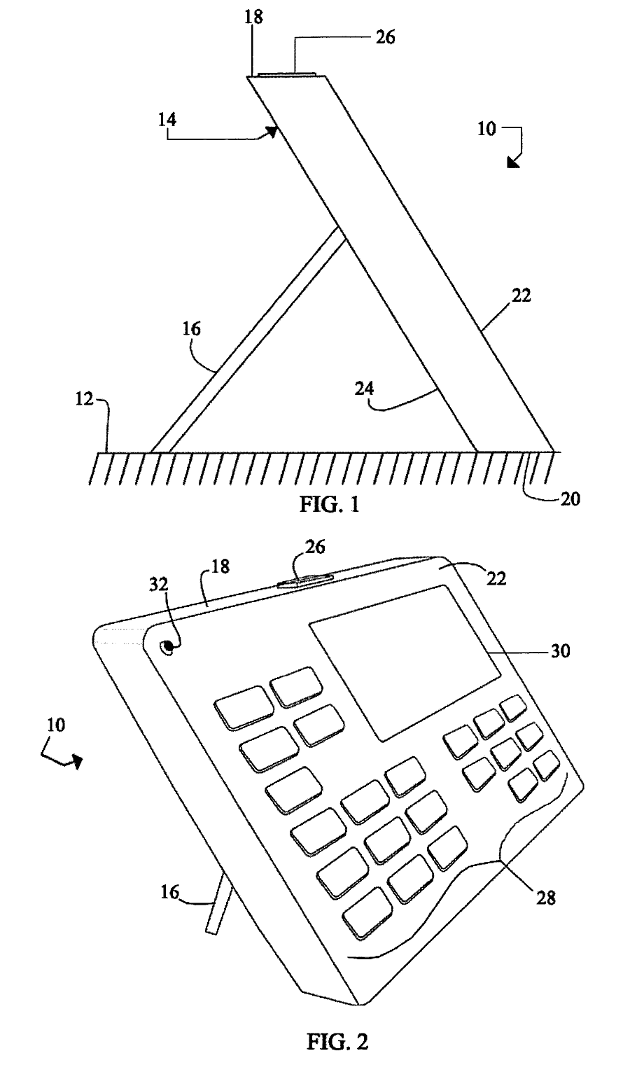

FIGS. 1-4 illustrate one examples of how a timer of the present invention can be implemented. FIGS. 1-4 show an example where the timer is designed for use in a test taking environment. As mentioned above, other implementations are also possible.

FIG. 1 is a side view of a timer 10 resting on a surface 12. The timer 10 includes a housing 14 and a plurality of buttons and one or more displays (described below). A fold-out stand 16 can be used to prop the housing 14 in the position shown in FIG. 1. With the timer 10 propped up, a user will have a clearer view of the buttons and display of the timer 10. The housing 14 of the timer has the shape of a parallelogram when viewed from the side. Top and bottom surfaces 18 and 20 are angled with respect to front and back surfaces 22 and 24 such that, when the timer 10 is propped up using the stand 16, the top surface 18 and bottom surface 20 are generally parallel to the surface 12, which makes the timer 10 more stable, as well as making the top surface 18 more accessible to the user.

FIG. 2 is an isometric view of the timer 10 shown in FIG. 1. FIG. 2 shows a button 26 formed on the top surface 18 of the timer. On the front surface 22 of the timer, a plurality of buttons 28, a display 30, and a light 32 are formed. The operation of the buttons 26 and 28, display 30, and light 32, are described in detail below.

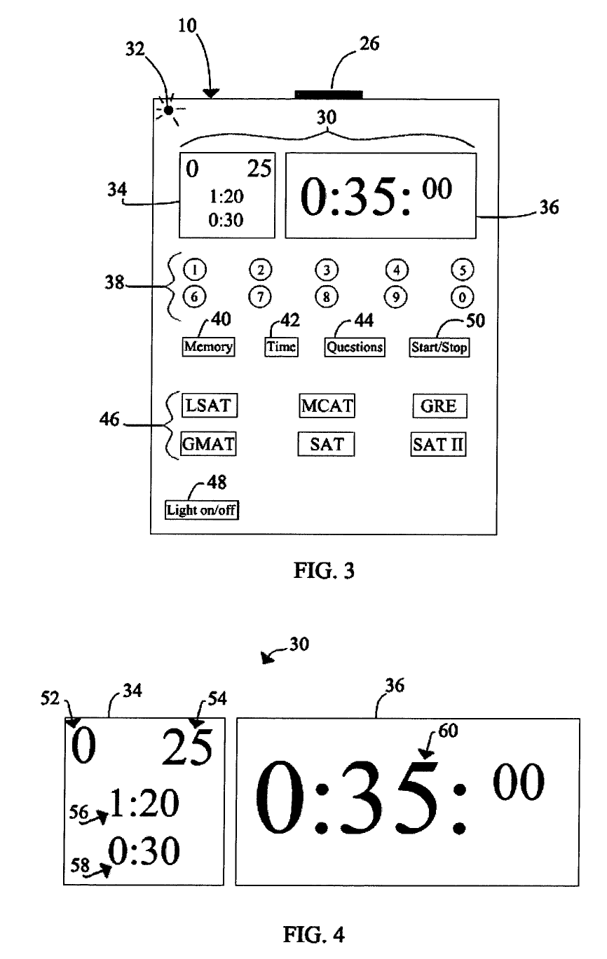

FIGS. 3 and 4 illustrates an example of a timer 10 of the present invention, showing exemplary controls and displays. A description of the functions of the various buttons and displays follows. The timer 10 has a button 26 that can be pressed by a user after finishing each question. Pressing button 26 updates the count of questions completed and recalculates question times. A warning light 32 lights at one-minute remaining, for example (or at any other alternative warning time chosen by a test taker). The timer 10 includes an LCD display 30, having, in this example, two portions, 34 and 36. The display 30 is shown in detail in FIG. 4. A plurality of number buttons 38 are provided for number entry by a user. A memory button 40 is used to store various individualized data, entered by a user. A time button 42 is used by a user to enter the total time allowed for a particular section of a test. A questions button 44 is used by a user to enter the total number of questions in a particular section of a test. A user presses question button 44 before entering the number of questions on a test using the number buttons 38. A plurality of standardized exam buttons 46 provide testing times and number of questions per section for various standardized exams, such as the LSAT, GMAT, MCAT, SAT, GRE, SAT II. Of course, the buttons could correspond to other exams or tasks as well. The exam buttons 46 allow the timer 10 to be used for various standardized tests, without the user having to manually enter the timers and number of questions for each test. The light on/off button 48 allows a user to turn the warning light 32 on or off. The start/stop button 50 allows a user to start and stop the timer 10.

FIG. 4 is an enlarged view of the display 30 shown in FIG. 3. The display 30 has two portions, 34 and 36. The display 30 displays various information relating to the operation of the timer. In the example shown in FIG. 4, the display 30 displays the following information. The number of questions completed is displayed at 52. The number of questions remaining is displayed at 54. The amount of time available per uncompleted question is displayed at 56. The time left on the current question is displayed at 58. The count up or count down of total time is displayed at 60.

The timer described above is a test-taking tool. The timer provides, down to the question, time specifics. The timer helps the user manage their time efficiently on each question.

Following is a description of an example of the operation of the timer described above in an examination environment. When the test taker is about to begin the test, they set a couple simple parameters that will help them gauge their time for each question. First, the total amount of time allowed for the test or test portion is entered (via time button 42 and number buttons 38). Second, the amount of questions for the test or test portion is entered (via questions button 44 and number buttons 38). For example, if the test has 25 questions and must be completed within 35 minutes, the student will hit the time button 42 and then enter 35:00 using the number buttons 38. Next, they will hit the questions button 44 and enter 25. Now the timer 10 is ready for the test to begin. After the student hits the start button 50, the timer 10 keeps a running total of the amount of time used during the test, as well as keeping track of time per question available. Alternately, the memory button 40 can be used (described below). In another example, a user can use one of the exam buttons 46 to automatically set the appropriate values for time and questions, without the need for manual entry (described below).

In the example described above, for a 35-minute, 25 question test, the student starts off with an average of 1 minute 24 seconds for each question. The timer counts down the amount of time that should be spent on each question and displays this amount of time at 58. For example, on the first question of the 35-minute test, the timer counts down (and displays at 58) from 1:24 to zero. This lets the student know how they are doing on time for each question.

After the student answers each question during a test, the student hits the button 26 on top of the timer 10, which resets both the time available per question and the question timer. For example, if the student spends 2 minutes on the first question (40 seconds too long), the student will hit the button 26 on top of the timer 10. Now, the time available per question (displayed at 56) will drop to 1:18. As displayed, there is now less time per question displayed for upcoming questions. If the student then answers the 2nd question in 0:30, the time per question available increases to 1:22. This process continues until the student is finished with the test. The number of questions completed (displayed at 52), and number of questions left (displayed at 54) also changes after each question.

Generally speaking, after each question is completed, the button 26 (i.e., the sub-completion trigger) is pressed. At that point, the test taker can be told, via the display or other user perceivable device: (1) the total amount of time the test will take to complete, assuming his answer completion pace remains unchanged; (2) how far ahead or behind he is on “time per question” basis; (3) how much more quickly the next question must be completed in order that the test taker be back on schedule to complete within the allotted time; and (4) a possible suggestion that a question or two be skipped in order to get back on pace.

The use of the button 26, the sub-completion trigger, to move to the next question is only one example of how the timer can be advanced to the next task. In other examples, the move to the next question can be triggered, for example, be voice activation. Or, the timer could know to move to the next question and recalculate time averages by feeling a vibration in the desk, or a whistle or other sound from the user. Or, he timer could be programmed for any combination of keys pressed to act as the sub-completion trigger.

In one example, an aspect of the timer of the present invention is that it does not make any sounds. Under standardized testing situations, sound is typically forbidden to come from a timer. No prior art timer is silent after the counter has reached zero.

The silence attribute is important for some uses of the timer. For example, during some tests, no noise can be made. In other applications or uses, it may be desirable for the timer to make noise, vibrate, or provide some other user perceivable notification. For example, if a runner is using the timer, the runner might need some audible cue that they had spent too much time on their current lap, and therefore that they needed to speed up. Similarly, a vibrating pulse through a watch on their arm could signify that too much time has been spent on a certain task.

Since athletic events are often timed, there is a method for using the invention to help minimize the time to complete the event. With the example of a runner, if the goal is to run 10 laps in a total of 20 minutes, it would be useful for the runner to know where he stands at key points along the way. With the timer, he can push the “sub-completion” button (similar to button 26 in the examples described above) at certain, discrete points along the way. If he chooses to divide the race into laps, he will push the “sub-completion” button at the end of each lap. At that time the runner can be told, either on the device itself, audibly, or both: (1) the total amount of time that will be expended on the race, assuming his pace remains unchanged; (2) how far ahead or behind he is of the required “per lap pace”; and/or (3) how much faster, from a time perspective, the next lap must be run in order to attain his targeted time.

In addition, the runner may choose to break the race into more parts, so that more “real time” adjustments are possible. For example, he can choose to break laps into halves or quarters, in which case there will be 20 and 40 discrete “sub-completion points” respectively. This means the runner will have many more chances of getting back on track.

In addition, if the runner has any “special” race strategies, these can be captured within the apparatus as well. For example, if the runner wishes to run the first 9 laps at one average speed, and then run the last lap at a somewhat faster speed, this can be incorporated into the data that, following each depression of the sub-completion button, tells him whether or not he is on course at each sub-completion point of the race. And, as with all other timed events, the runner will get the results down to the second.

Following is an example of how the light 32 can be used to alert a user to certain events during a test. When the test has 1 minute remaining, the light 32 (e.g., a red flashing LED) goes off alerting the student to rapidly fill in the answers for all remaining questions. Also, if at any point of the test, too much time is spent on the current question, the warning light 32 is flashed 3 times to notify the user that they should consider moving onto the next question. In this specific example, if there is 1 minute 15 seconds for a question, once the per question timer counts down to 0, the light will flash 3 warnings and then begin to-count negatively. The warning light feature can be disabled with the light on/off button 48. A timer of the present invention may include any desired warnings, depending on the use of the timer, or on needs of a user. In addition, events that trigger warnings can be customized by an individual user.

If a test has several sections that have the same time limit, the student can use the memory button 40 to remember the settings from the prior section. A user can simply enter the time for the test and the number of questions, and then hold down the “Memory” button 40 for 3 seconds. The time and question combination is now stored in memory and the next time “Memory” is pushed, the stored information will appear.

There are a set of very common tests taken in the United States, including the LSAT, MCAT, SAT, SAT II, GMAT, and GRE. The timer may include specific memory buttons for these major tests (e.g., buttons 46 shown in FIG. 3). So, if a user is taking the LSAT, the user can press the “Time” button 42 and then the “LSAT” button 46, and the correct time will automatically be displayed. Similarly, for the question amount, the user presses the “Questions” button 44 and then the “LSAT” button 46, and the amount of questions that appear on the LSAT appears automatically. If the test has more than one number of questions that is standard, then each time you press the “LSAT” button 46 the question amount rotates among various stored numbers of questions.

The timer of the present invention is designed to help people time their everyday activities and complete tasks in a timely manner. In order to give the most benefit to those using the timer, various methods or strategies for use of the timer may be used. These methods relate to the best manner in which to use the timer to take control of tasks and time management. For example, for standardized tests, there are several different tests to take, including the SAT, ACT, LSAT, MCAT, etc. Each test has some basic timing strategies that are necessary to understand and to maximize test management, and therefore scoring ability. But each test also has specific attributes that distinguish them from other tests when it comes to timing. They are all different lengths, contain different types of question logic, and demand different per-question timing strategies. The time of the present invention may be used with specific time management skills that can be maximized by utilizing the functions and applications of the timer. A key element in this strategic approach involves the calculations that are programmed into the apparatus. Then, each time the sub-completion button is triggered, the user is given information, generated by the apparatus that guides his/her actions at that point. For example, the SAT has a simple structure. It is widely held that the first questions in an SAT test section are easier than the later ones. All questions are worth the same amount. And, there is a penalty for guessing, incorrect questions are worth more than blank questions. One example of a time management technique would be to spend more time on the early questions, making sure to get them right, since they are worth just as much as the hard ones. In order to facilitate this time management technique, the apparatus would take this fact into consideration. For example, if it is estimated that 5 questions will not be able to be completed, the amount of time per question can be increased. This will assure that the test taker is less likely to run out of time on the earlier, less difficult questions, since the 3 light flashes will occur after more time has passed. For each exam with known testing differences, the there is an optimizing method which can be employed, and which will give the test taker statistical updates each time the sub-completion button is depressed.

In certain instances, an event will include tasks with different levels of importance. An example is a business person whose “to do” list has tasks ranked from least valued (Task Level 3), to median valued (Task Level 2), to most valued (Task Level 1). If we assume that Level 1 tasks are twice as valuable as Level 3 tasks and 1.5 times more valuable than Level 2 tasks, the apparatus can be programmed and a method utilized to optimize the management and completion of these tasks. After each category of task is entered, using a sub-completion command (for example, entering *1 for each Level 1 task completed, *2 for each Level 2 task completed, and *3 for each Level 3 task completed), the person may told: (1) the total amount of time that will be expended on completing all the tasks assuming his pace remains unchanged; (2) how far ahead or behind he is of the required “per task completion pace”; and/or (3) how much faster the next task (by level) must be completed in order for all the tasks to be completed within the allotted time.

In the preceding detailed description, the invention is described with reference to specific exemplary embodiments thereof. Various modifications and changes may be made thereto without departing from the broader spirit and scope of the invention as set forth in the claims. The specification and drawings are, accordingly, to be regarded in an illustrative rather than a restrictive sense.

What is claimed is:

1. A method of displaying examination information during one or more portions of an examination, comprising the steps of:
providing a timer for timing the duration of a portion of the examination;
tracking the number of questions answered by a user during the portion of the examination; and
displaying information relating to both the time remaining in the portion of the examination and to the number of questions remaining in the portion of the examination.

2. The method of claim 1, wherein the displayed information includes an average amount of time remaining per remaining questions.

3. The method of claim 1, wherein the displayed information is a number equal to the time remaining divided by the number of remaining questions.

4. The method of claim 1, further comprising the step of displaying the amount of time elapsed during the portion of the examination.

5. The method of claim 1, further comprising the step of displaying the amount of time remaining in the portion of the examination.

6. The method of claim 1, further comprising the step of displaying the number of questions answered.

7. The method of claim 1, further comprising the step of displaying the number of questions remaining.

8. The method of claim 1, further comprising the step of providing memory for storing information relating to one or more specific standardized examinations.

9. The method of claim 8, wherein the duration of and the number of questions in the portion of the examination is stored in the memory.

10. The method of claim 8, wherein information relating to a plurality of specific standardized examinations is stored in the memory, the method further comprising the step of allowing a user to select predetermined parameters for an examination based on the stored information.

11. The method of claim 1, further comprising the step of activating a visual indicator to alert a user of an event relating to the operation of the timer.

12. The method of claim 11, wherein the user is alerted without using an audible device.

13. The method of claim 1, wherein the information is displayed on a computer monitor.

14. The method of claim 1, wherein the information is displayed on a display of an electronic device.

15. A timer for timing an event comprising:
a display;
one or more buttons for allowing a user to start and stop the timer; and
a visual indicator for alerting a user to an event, wherein the user is alerted without using an audible device.

16. The timer of claim 15, further comprising a sub-event button for allowing a user to time sub-events by pressing the sub-event button during the timed event.

17. The timer of claim 16, wherein the display displays information relating to the duration of a sub-event.

18. The timer of claim 17, wherein the display displays an average amount of time allowed for future sub-events during the timed event.

19. The timer of claim 16, wherein the display displays the number of past sub-events.

20. The timer of claim 15, wherein the display displays the number of future sub-events.

21. The timer of claim 16, wherein the display displays statistical information related to the timed event the sub-events

22. A method of displaying information during a timed event having sub-events, comprising the steps of:
providing a timer for timing the duration of the event;
tracking the number of sub-events during the event; and
displaying information relating to both the time remaining in the event and to the number of sub-events.

23. The method of claim 22, wherein the displayed information includes an average amount of time remaining per remaining sub-event.

24. The method of claim 22, wherein the displayed information includes the number of past sub-events.

25. The method of claim 22, wherein the displayed information includes the number of sub-events left during the timed event.

26. The method of claim 22, further comprising the step of activating a visual indicator to alert a user of the end of a timed period.

27. The method of claim 26, wherein the user is alerted without using sound.
